(19) United States
(12) Patent Application Publication
(10) Pub. No.: US 2018/0047213 A1
(43) Pub. Date: Feb. 15, 2018

(54) METHOD AND APPARATUS FOR PROVIDING AUGMENTED REALITY-BASED DYNAMIC SERVICE

(71) Applicant: KOREA ADVANCED INSTITUTE OF SCIENCE AND TECHNOLOGY, Daejeon (KR)

(72) Inventors: Woon Tack WOO, Daejeon (KR); Tae Jin HA, Daejeon (KR); Jae In KIM, Daejeon (KR)

(21) Appl. No.: 15/559,810

(22) PCT Filed: Jun. 10, 2015
(86) PCT No.: PCT/KR2015/005831

§ 371 Date: Sep. 19, 2017

(30) Foreign Application Priority Data
Mar. 20, 2015 (KR) 10-2015-0038533
Jun. 10, 2015 (KR) 10-2015-0081767

(51) Int. Cl. G06T 19/00; G06T 15/20; G06F 17/30

(52) U.S. Cl. CPC G06T 19/006; G06F 17/30041; G06T 15/20; G06K 9/00671

(57) ABSTRACT

The present invention includes the steps of: collecting data associated with a preset authoring item based on a predetermined viewing point within content to be guided, when an authoring mode; rendering authoring item-specific data collected based on a preset augmented reality content service policy, matching the rendered data to metadata corresponding to the viewing point, and storing the matched data; checking the metadata of the viewing point; and as a result of the checking, matching the metadata to the content displayed in the viewing region and augmenting the content.

### TECHNICAL FIELD

The present invention relates to viewing point authoring and view for an augmented reality-based guide service.

### BACKGROUND ART

The initial study on augmented reality authoring is the Authoring 3D Hypermedia for Wearable Augmented and Virtual Reality [1] of the University of Colombia in the United States. In this regard, an author inserts a variety of multimedia based on a map of a virtual space to allow a viewer to view authored content by using an outdoor mobile augmented reality system.

Among recent studies, Google Auto Awesome [2] shows the study of, when a user takes a picture and uploads the picture to a server, automatically generating a travel record based on time and location information.

On a view side, the study of Georgia Tech's exploring spatial narratives and mixed reality experiences in Oakland Cemetery [3] was carried out to improve the experience of viewing by enhancing narration by using a GPS sensor. The study of Museum of London: Streetmuseum [4] displays a photograph taken in the past on a camera image based on location so that a viewer can see a past figure on the spot. In the case of AntarcticAR [5], location information is visualized by presenting a direction and a distance of each content on a map based on a location of a user, so that a user could navigate to the content based on the direction that the user faced.

Such experiences are merely a representation of voice or photograph on an image based on planar location information within a map.

### DETAILED DESCRIPTION OF THE INVENTION

### Technical Problem

Accordingly, the present invention provides augmented reality authoring and view for viewing point visualization, wherein viewing point information is stored through capturing of a scene of interest, and related multimedia content, narration, or the like corresponding to a viewing point for each author are added, so that a user can acquire information about an object of interest in an optimal viewing point.

### Technical Solution

An aspect of the present invention includes the steps of: collecting data associated with a preset authoring item based on a predetermined viewing point within content to be guided, when an authoring mode for supporting a viewing point-based information provision service is executed at the time of performing a service for providing an augmented reality-based content service; rendering authoring item-specific data collected based on a preset augmented reality content service policy, matching the rendered data to metadata corresponding to the viewing point, and storing the matched data; checking the metadata of the viewing point of the content displayed in a preset cycle-specific viewing region based on a user's status information sensed when executing a view mode; and as a result of the checking, when the metadata of the viewing point coincides with the viewing point-specific metadata corresponding to the content, matching the metadata to the content displayed in the viewing region and augmenting the content. The content is a real 3D space viewed according to a user's movement or a predetermined scenario-based virtual reality space.

Another aspect of the present invention includes a content server configured to: when an authoring mode for supporting a viewing point-based intonation provision service is supported at the time of performing a service for providing an augmented reality-based content service and the authoring mode associated with augmented reality-based content authoring is executed from a client terminal linked via a network, collect data associated with a preset authoring item based on a predetermined viewing point within content to be guided, render authoring item-specific data collected based on a preset augmented reality content service policy, match the rendered data to metadata corresponding to the viewing point, and store the matched data; and check the metadata of the viewing point of the content displayed in a preset cycle-specific viewing region based on a user's status information sensed at the time of executing a view mode associated with an augmented reality-based content view request from the client terminal, and as a result of the checking, when the metadata of the viewing point coincides with a viewing point-specific metadata corresponding to the content, match the metadata to the content displayed in the viewing region, and augment the content.

### Advantageous Effects

According to the present invention, evolved content for the augmented reality-based content service can be continuously generated. Optimized content for each viewing point can be provided by using the content search function focused on content optimized for content displayed on the display of the user terminal based on a real 3D space or a predetermined scenario. It is possible to provide an adaptive augmented reality-based content service which is interactive between a user and an author and can acquire desired information by just approaching the user terminal to the object of interest without a user's separate searching operation focused on the viewing point-specific authoring. Therefore, space telling with more reinforced experience can be achieved.

### DESCRIPTION OF THE DRAWINGS

FIG. 1 is an overall flowchart of a method for providing an augmented reality-based dynamic service according to an embodiment of the present invention.

FIG. 2 is a diagram schematically illustrating an example of an operation flow between a client (author or user) and a server which provides an augmented reality-based dynamic service, in the method for providing the augmented reality-based dynamic service according to the embodiment of the present invention.

FIG. 3 is a flowchart showing an operation of an augmented/virtual reality-based content authoring and visualization software platform to which the method for providing the augmented reality-based dynamic service according to the embodiment of the present invention is applied.

FIG. 4A and FIG. 4B are diagram illustrating an example of a screen to which the method for providing the augmented reality-based dynamic service according to the embodiment of the present invention is applied.

FIG. 5 is a diagram illustrating an example of coded information associated with the method for providing the augmented reality-based dynamic service according to the embodiment of the present invention.

FIG. 6 is a diagram illustrating an example of an access to an XML file and a content resource-related folder in the method for providing the augmented reality-based dynamic service according to the embodiment of the present invention.

FIG. 7 is a diagram illustrating an example of a user location/gaze information visualization concept image in the method for providing the augmented reality-based dynamic service according to the embodiment of the present invention.

FIG. 8 is a diagram illustrating an example of a screen when a visualization concept image is applied to an actual screen, in the method for providing the augmented reality-based dynamic service according to the embodiment of the present invention.

FIG. 9 is a diagram illustrating an example of an authoring content confirmation screen by a call of an XML file present in a content server on a web browser, in the method for providing the augmented reality-based dynamic service according to the embodiment of the present invention.

### MODE OF THE INVENTION

Hereinafter, preferred embodiments of the present invention will be described in detail with reference to the accompanying drawings. In the following description, particular matters such as specific elements are provided, but they are provided only for easy understanding of the present invention. It is obvious to those skilled in the art that these particular matters can be modified or changed without departing from the scope of the present invention.

The present invention relates to viewing point authoring and view for an augmented reality-based guide service. More specifically, when an authoring ode is executed, data associated with a preset authoring item based on a predetermined viewing point within content to be guided is collected and stored as metadata. Metadata of the viewing point of content displayed in a preset cycle-specific viewing region is checked based on a user's status information sensed when executing a view mode. When coinciding with the metadata of the predetermined viewing point corresponding to the content, the metadata is augmented by matching the content displayed in the viewing region, so that a user can acquire information about a plurality of objects of interest present within the viewing point through visualization of the viewing point corresponding to a currently visually observed current or content. By analyzing a user's motion information sensed according to a user's interrupt in the content displayed on a display of a user terminal based on a real 3D space or a predetermined scenario, information about the viewing point corresponding thereto (including, for example, multimedia content, camera viewpoint, and narration) is adaptively authored and stored as viewing point-specific metadata of the content or provided as authoring information corresponding to a prestored viewing point. Thus, evolved content for the augmented reality-based content service can be continuously generated. In addition, optimized content for each viewing point can be provided by using the content search function focused on content optimized for content displayed on the display of the user terminal based on a real 3D space or a predetermined scenario. It is possible to provide an adaptive augmented reality-based content service which is interactive between a user and an author and can acquire desired information by just approaching the user terminal to the object of interest without a user's separate searching operation focused on the viewing point-specific authoring. Therefore, space telling with more reinforced experience can be achieved.

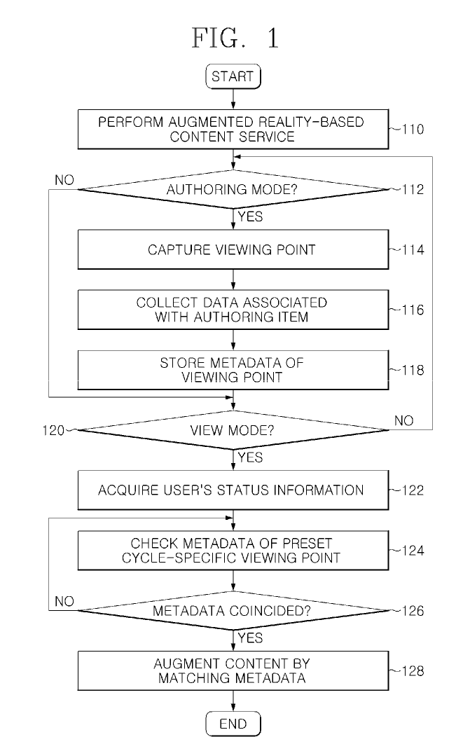

Hereinafter, a method for providing an augmented reality-based dynamic service according to an embodiment of the present invention will be described in detail with reference to FIG. 1.

FIG. 1 is an overall flowchart of a method for providing an augmented reality-based dynamic service according to an embodiment of the present invention.

Referring to FIG. 1, an augmented reality-based content service, to which the present invention is applied, is performed in operation 110.

The content is a real three-dimensional (3D) space viewed according to a user's movement or a predetermined scenario-based virtual reality space. The content, to which the present invention is applied, is serviced in such a manner that an augmented or virtual reality is displayed in a viewing region as described below in sequence. The content may includes a real 3D space which is supported through execution of a specific program or application of a user terminal, or is searched through the Internet and serviced, or is received from a remote service server and serviced, or is input from a viewing region through a user's photographing. In this case, the content searched through the Internet may be content corresponding to a virtual space. The content according to an embodiment of the present invention collectively refers to all content which is continuously updated and evolved through interaction-based feedback (for example, modification/supplement) between a content author and a content user.

In operation 112, it is checked whether a current mode is an authoring mode by checking a mode switching of a mode switching unit through a user's selection at the time of performing a service for providing the augmented reality-based content service in the user terminal.

When it is checked that the current mode of the user terminal is the authoring mode, the process proceeds to operation 114 to capture a predetermined viewing point of currently displayed content.

The authoring mode is a mode for providing information including camera viewpoint, narration, and related multimedia content based on a corresponding viewing point of content. The capturing is performed for corresponding information acquisition for viewing point visualization. Specifically, in the case of information at a viewpoint when an author captures a scene of interest in the authoring mode, that is, in the case of a currently photographed 3D space, or in the case of a virtual space provided through a remote service server (cloud server, content server, or the like) interworking via a network or provided through Internet search, the viewing point of the content is recognized through acquisition of 3D location, 3D rotation, and GPS information (sensed through a sensor provided in the user terminal) of the terminal of the author within the content according to attribute information of the corresponding content (museum, exhibition, concert, map, or the like), and overall information of a plurality of objects in the recognized viewing point or the corresponding viewing point is stored.

In other words, a narrator (or viewer) takes a photograph of an object of interest while moving with a user terminal equipped with a camera. At this time, the viewing point is stored through estimation of the location of the user and the pose of the camera.

Alternatively, the contents authored by the author on the spot are displayed in the background of the map, and the author in an offline environment can confirm and modify or supplement the authored contents online. Various viewing stories can be created through authoring such as setting of the order of viewing points or setting of a tour path based on spatial unit.

Subsequently, in operation 116, data associated with a preset authoring item based on the viewing point captured in operation 114 is collected.

The data associated with the preset authoring item is data including camera viewpoint, narration, and related multimedia content, and may be collected by broadcasting necessary data through at least one service server distributed over the network.

Through the data collected by the broadcasting, the author records and stores a description of a scene of interest based on a viewing point, or searches and stores related multimedia content together.

In this case, the related multimedia content is content corresponding to the highest priority based on similarity among a plurality of content searched through association analysis based on preset related data based on a scenario of the corresponding content (flow developed according to the theme of the content) and is provided to the author through an authoring interface in the authoring mode.

In other words, according to the embodiment of the present invention, it is possible to author content based on the virtual reality environment at a remote place or to author content based on the augmented reality environment on the spot. The content that can be authored includes camera viewpoint, narration, and related multimedia content that enable information provision based on the viewing point. In this case, as for the related multimedia content, content (texts, pictures, photos, videos, and the like) having the highest relevance (utilizing content meta information) based on analysis of context information (tag/keyword search, location, object-of-interest identifier, and the like) is automatically searched based on prestored metadata of the viewing point, and may be used when the author performs authoring. An annotation of an image method and a visual effect using a color and an image filter may be added to a scene corresponding to the viewing point.

In operation 118, authoring item-specific data collected based on a preset augmented reality content service policy is rendered, the rendered data is matched to metadata corresponding to the viewing point, and the matched data is stored.

The metadata means detailed information corresponding to each viewing point. In order to identify multiple viewing points within the content, the metadata includes a content type of the viewing point, an identifier, location information within the content, detailed information for each object present in each preset viewing point region, and response. A region of the viewing point is set based on a specific object when the corresponding content is generated. Alternatively, the viewing point is classified into a plurality of viewing points at predetermined intervals according to the content type, and authoring item-specific data collected by matching the prestored metadata corresponding to a specific object of the viewing point captured when the author captures the viewing point is stored. Alternatively, the captured viewing point is searched at the classified viewing point of the corresponding content, data is matched to the metadata of the searched view point, and the matched data is stored.

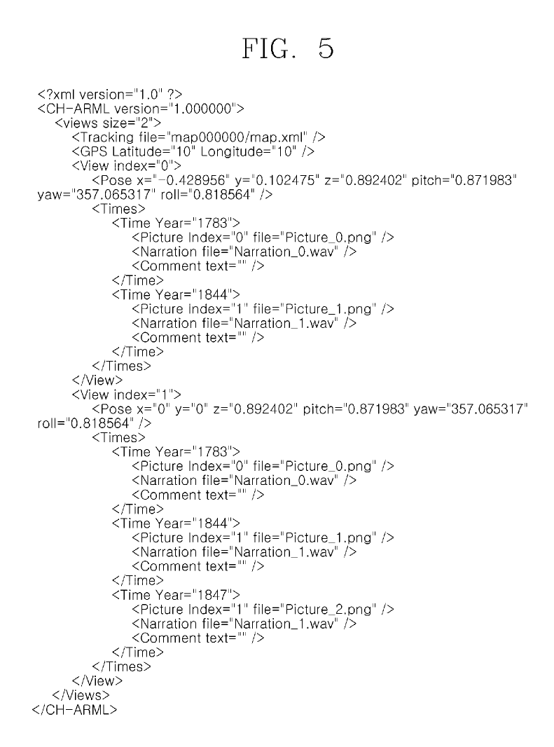

A point of a feature map corresponding to the viewing point upon completion of the authoring mode, and Information such as keyframe images, camera viewpoint pose information, GPS location coordinates, recorded files, and camera images are stored in a content database (DB) of a content server in the form shown in FIG. 5. At this time, the information standard takes the form of Extensible Markup Language (XML) and includes one GPS value, one feature map data, and N viewpoint view nodes.

N pieces of augmented content are included in the viewpoint view.

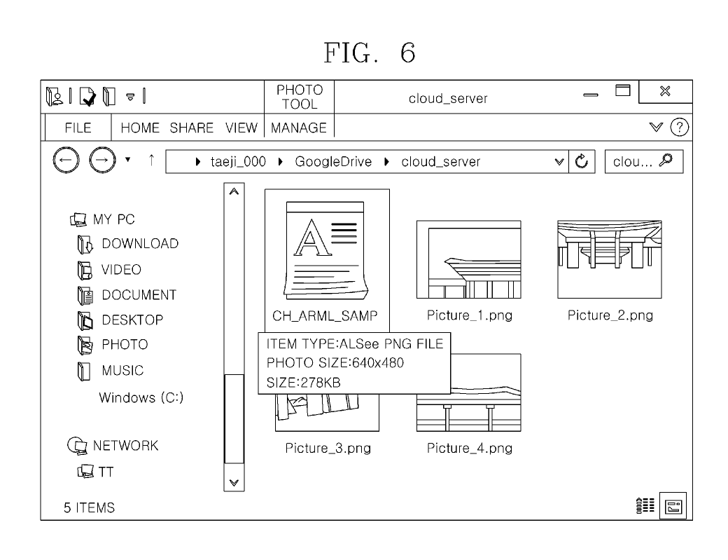

The stored XML file and content resources can be accessed through the folder, as shown in FIG. 6. When the viewing point is stored on the spot, media files such as images and audios corresponding to the stored viewing point are stored in the content DB of the content server in real time.

In this case, when the authoring mode for supporting the viewing point-based information provision service is supported at the time of providing the service for providing the augmented reality-based content service and the authoring mode associated with the augmented reality-based content authoring is executed from the client terminal connected via the network, the content server according to an embodiment of the present invention collects the data associated with the pre-configure authoring item based on the predetermined viewing point within the content to be guided, renders the authoring item-specific data collected based on the preset augmented reality content service policy, matches the rendered data to metadata corresponding to the viewing point, stores the matched data, checks the metadata of the viewing point of the content displayed in a preset cycle-specific viewing region, based on a user's status information sensed at the time of executing a view mode associated with an augmented reality-based content view request from the client terminal, and when the metadata of the viewing point coincides with viewing point-specific metadata corresponding to the content, augments the metadata by matching the metadata with the content displayed in the viewing region, and provides the metadata to the corresponding client terminal.

Subsequently, in operation 120, it is checked whether the mode is switched to the view mode. When it is checked in operation 120 that the mode is switched to the view mode, the process proceeds to operation 122 to acquire sensed status information of the user.

The status information of the user is acquired through, for example, a user's touch screen input (two-dimensional (2D) touch screen coordinate information, touch input, swipe input information, or the like) based on an information processor in which visualization software is installed, and motion input information (3D rotation information or the like) based on a viewing device. The status information of the user includes a color image from a camera connected to the information processor, a depth-map image in the case of using a depth camera, 3D movement and 3D rotation information in the case of using an electromagnetic sensor, acceleration and gyro sensor-based motion information (3D rotation information) of the viewing device, compass sensor information (one-dimensional (1D) rotation information), GPS sensor information (2D movement coordinates), and the like.

Also, in order to acquire six degrees of freedom (6DoF) pose including movement and rotation information of a camera mounted on an information processor (for example, a camera of a smartphone) or a camera mounted on a head mounted display, an electromagnetic sensor, an image-based camera tracking technology (which can acquire 3D movement and 3D rotation information based on an object from which feature points can be extracted within a near/far distance), and a built-in motion sensor (which can acquire 2D location information based on a GPS sensor, yaw rotation direction information using a compass sensor, and 3-axis rotation information using a gyro sensor) can be used.

In operation 124, the metadata of the viewing point of the content displayed in the preset cycle-specific viewing region is checked based on the status information of the user. In operation 126, it is checked whether the metadata of the viewing point coincides with the viewing point-specific metadata corresponding to the content. When the metadata of the viewing point coincides with the viewing point-specific metadata corresponding to the content, the process proceeds to operation 128 to augment the content by matching the metadata with the content displayed in the viewing region.

More specifically, in the view mode, the motion information of the user is acquired in the real 3D space viewed according to the user's movement or the predetermined scenario-based virtual reality space, and when the acquired motion information coincides with the viewing point-specific metadata corresponding to the content, a visual cue capable of augmented reality experience is presented to guide a user to a preferred viewing point for each object. When the user accesses content of a specific location so as to allow the viewer to interactively experience content authored in a virtual reality or augmented reality environment, the visual cue capable of augmented reality experience based a precise camera pose tracking technology is presented to the viewer so that the viewer can easily find the viewing point.

The corresponding viewpoint is the best viewpoint to view the object When the user accesses the viewing point, the authored content (texts, pictures, photos, videos, narrations, annotations, and the like) appears. Such a visualization method differs from an existing inaccurate augmented reality application technology based on a GPS sensor. When the user does not access specific content, the access of the user is guided by showing location information through a virtual map.

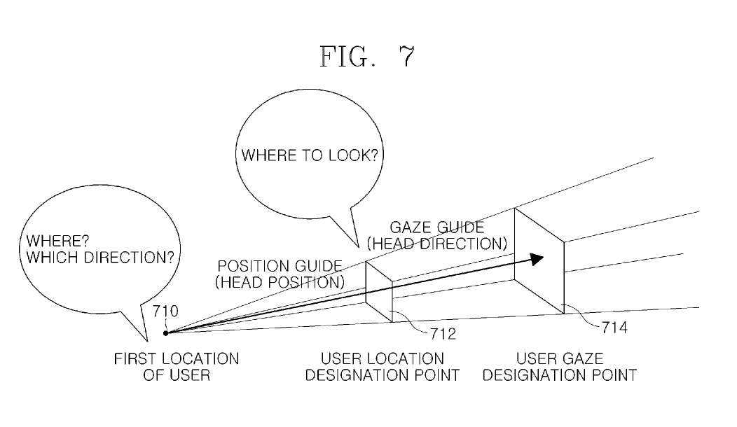

Referring to FIG. 7, when the user accesses a specific viewpoint, information annotation linked to the object is visualized. The location of the annotation is mapped in advance from the author (curator or another user) so that the user can easily know gaze information about where to look or a place at which the user should look.

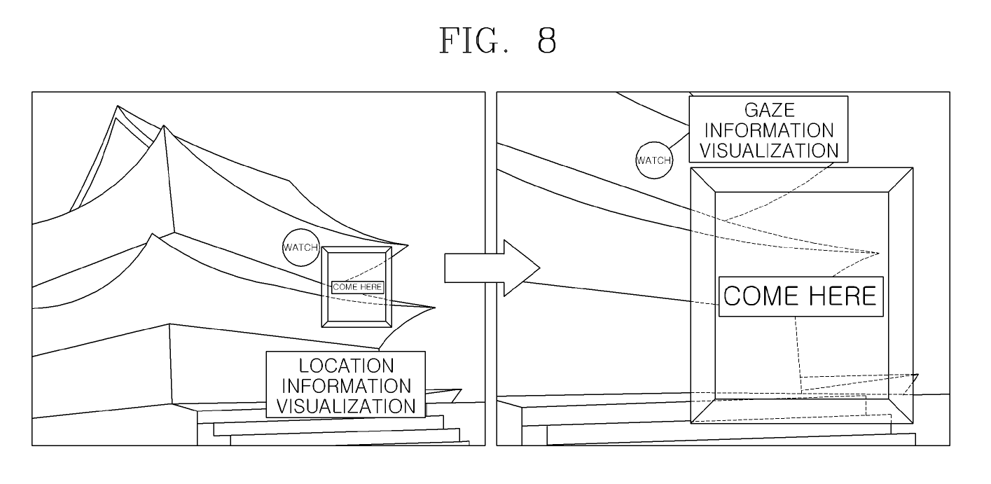

Meanwhile, FIG. 8 is a diagram illustrating an example of a screen in which the visualization concept image of FIG. 7 is applied to an actual screen. As shown in FIG. 8, the left side shows the location information visualization in a state of being far apart, and the right side shows the access to a location information point.

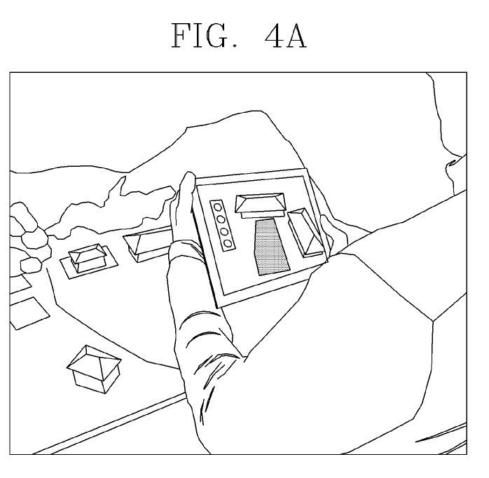

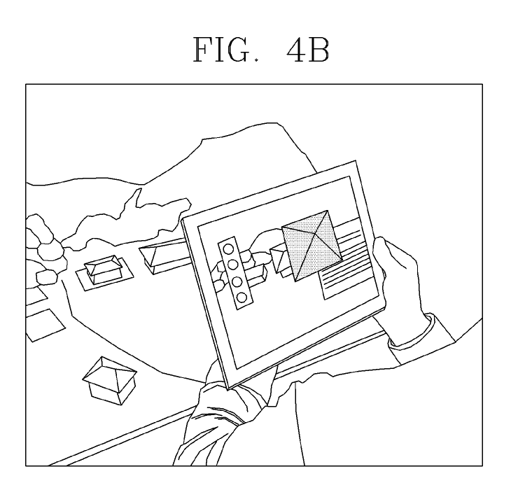

FIG. 4A and FIG. 4B are diagram illustrating an example of a screen in which the method for providing the augmented reality-based dynamic service according to the embodiment of the present invention is applied. As shown in FIG. 4A, the viewing point of the user is guided to the authored viewing point. As shown in FIG. 4B, when the viewer moves to the viewing point, the authored content is augmented.

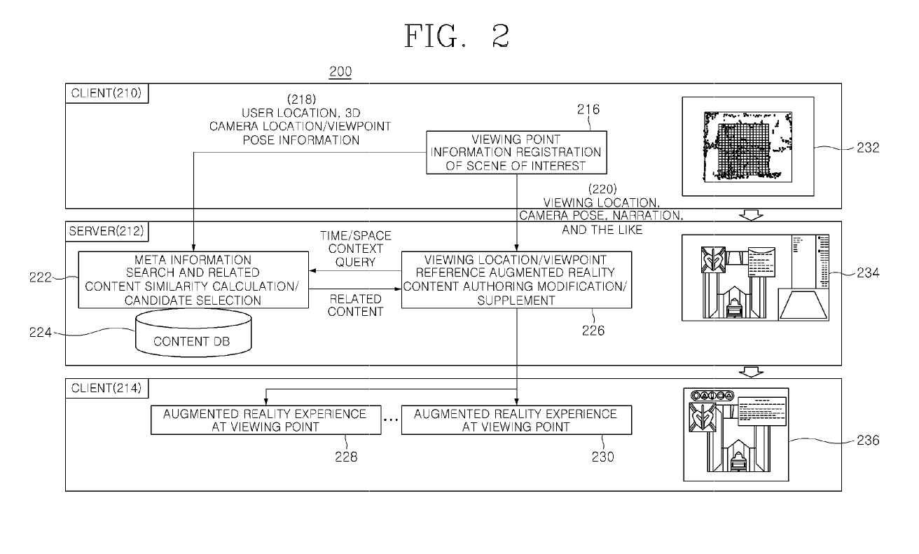

The augmented reality-based viewing point authoring and experience process of FIG. 1 will be described with reference to FIG. 2. FIG. 2 is a diagram schematically illustrating an operation flow between a client (author or user) and a server which provides an augmented reality-based dynamic service, in the method for providing the augmented reality-based dynamic service according to the embodiment of the present invention. In order for viewing point information registration S216 of the scene of interest, the client 210 corresponding to the author transmits user location, 3D camera location/viewpoint pose information 218 and information 220 about viewing location, camera pose, narration, and the like to the server 212.

The server 212 performs meta information search and related content similarity calculation/candidate selection 222 for the viewing point through the content DB 224 with respect to the user position, 3D camera location/viewpoint pose information 218 received from the client 210, performs viewing location/viewpoint reference augmented reality content authoring modification/supplement 226 with respect to the information 220 about the viewing location, the camera pose, the narration, and the like, and transmits the results to the user terminal corresponding to the client 214.

In this case, in the operations of the meta information search and related content similarity calculation/candidate selection 222 and the viewing location/viewpoint reference augmented reality content authoring modification/supplement 226, the related content is provided during the viewing location/viewpoint reference augmented reality content authoring modification/supplement 226. In the operation of the viewing location/view point reference augmented reality content authoring modification/supplement 226, information according to time/space context query is provided through the operation of the meta information search and related content similarity calculation/candidate selection 222.

In the user terminal of the client 214, viewing location/viewpoint reference augmented reality content authoring data registered at the predetermined viewing point is provided through augmented reality experiences 228 and 230 in the viewing point.

The operation flows for each structure of FIG. 2 are schematically shown in screens 232, 234, and 236.

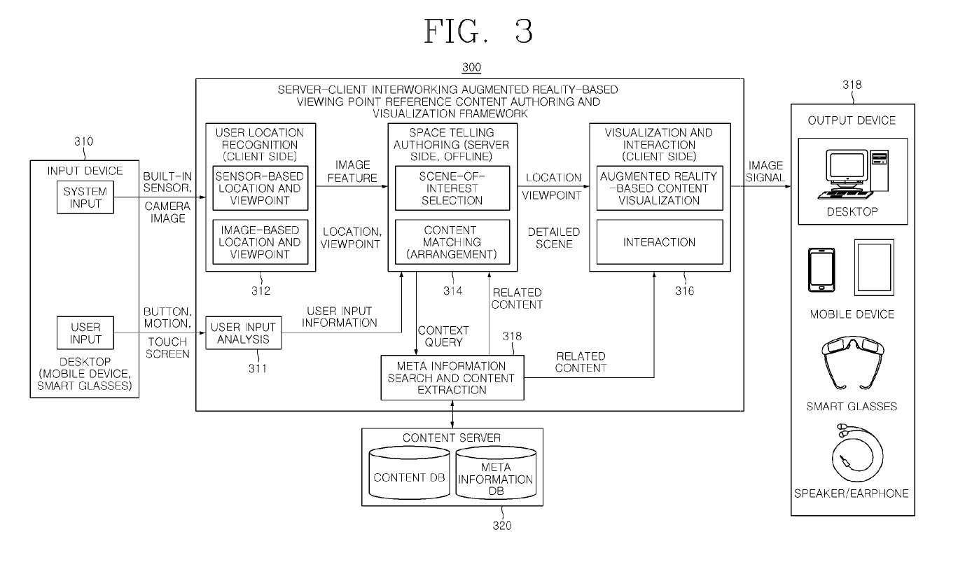

FIG. 3 is a flowchart showing an operation of an augmented/virtual reality-based content authoring and visualization software platform to which the method for providing the augmented reality-based dynamic service according to the embodiment of the present invention is applied.

Referring to FIG. 3, in the case of built-in sensor and camera image data input based on a system input in an authoring mode according to a mode set to a terminal through an input device 310 of the terminal, user location recognition is performed by classifying sensor-based location and viewpoint, or image-based location and viewpoint through execution of operation 312, and space telling authoring is performed through scene-of-interest selection and content matching (arrangement) by execution of operation 314.

Data in which information about the location, viewpoint, and viewing point is specified through operation 314 is visualized through augmented reality-based content visualization and interaction between the author and the user in operation 316 and is output to a display of an output device 318.

Meanwhile, button, motion, and touch screen-based user input through the input device 310 of the terminal in the view mode acquire user input information through user input analysis 311, and the intention of the user is output in operation 314 to perform space telling authoring through the scene-of-interest selection and content matching (arrangement). The space telling authoring is performed by using meta information search and content extraction 313 with respect to context query through operation 313. At this time, the related content is provided during the space telling authoring through the meta information search and content extraction 313, and the meta information search and content extraction 313 is performed based on the content DB and the meta information DB of the content server 320.

An example of utilizing the augmented/virtual reality-based content authoring and visualization software framework, to which the method for providing the augmented reality-based dynamic service according to the embodiment of the present invention is applied, will be described. First, according to an example of utilizing an in-situ authoring-based visualization system, the narrator (or viewer) moves while carrying a mobile device equipped with a camera. The narrator takes a picture of an object of interest. At this time, the viewing point is stored through estimation of the user location and the camera pose. Related content may be additionally searched and stored. Information authored based on a map is stored. Additional authoring may be performed later in an offline virtual reality environment.

According to an example of utilizing virtual reality-based visualization software in a desktop and web environment, the contents authored by the author on the spot are displayed in the background of the map, and the author in an offline environment can confirm and modify or supplement the authored contents online. Various viewing stories can be created through authoring such as setting of the order of viewing points or setting of the tour path based on spatial unit.

According to an example of utilizing visualization software for viewing users, the viewer can download the visualization software and select the authored viewing story. The downloaded story may dynamically change the tour path according to a user's profile (interest, interesting sights, desired end time, and the like) to thereby enable personalized story experience. A story point is displayed based on the map, and when the viewer moves to a nearby position, the visual cue is visualized. The viewer can experience the story according to the viewpoint of the narrator.

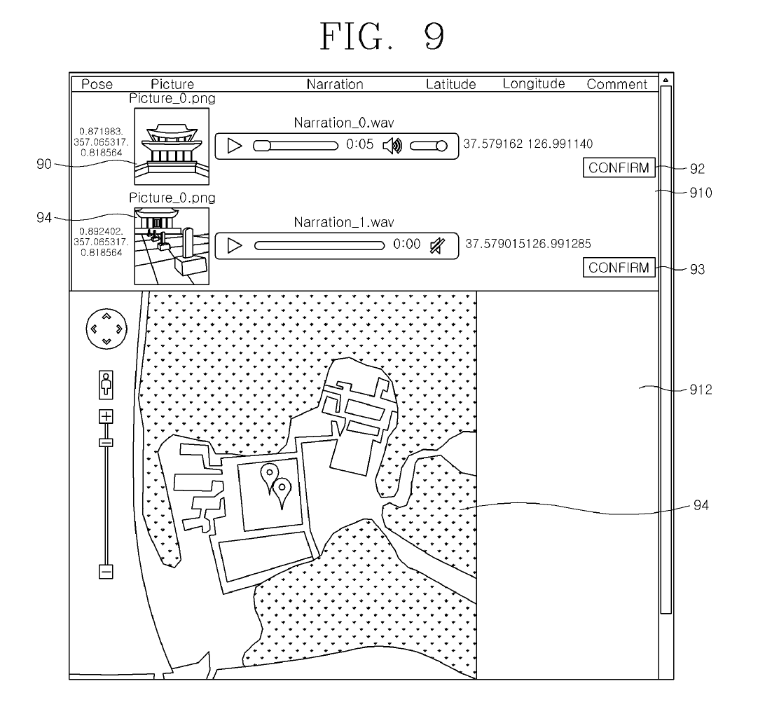

FIG. 9 is a diagram illustrating an example of an authoring content confirmation screen by a call of an XML file present in a content server on a web browser, in the method for providing the augmented reality-based dynamic service according to the embodiment of the present invention.

Referring to FIG. 9, the screen has a plurality of divided regions 910 and 912. Content display items (pose, picture, narration, latitude, longitude, comment, and the like) preset for each object 90 and 91 are arranged and displayed in the first region 910 in a preset order. A comment set to the corresponding object or stored by user definition is activated and displayed according to an interrupt generated in a confirmation block 92 or 93 marked in a portion of the first region 910. One or all of object-related locations of the objects displayed in the first region 910 are displayed in the second region 912 based on a GPS coordinate-based map 94 according to an operation of moving a user interrupt position.

At this time, the object present on the movement path is displayed in the first region 910 according to the movement path based on the user interrupt of the GPS coordinate-based map 94 displayed in the second region 912 in which the objects 90 and 91 are displayed, so that the corresponding information from the content server is provided according to the preset content display items. At least one or more pieces of object-related information are listed and displayed.

Accordingly, the item in the first region 910 is changed according to the user interrupt on the GPS coordinate-based map 94 displayed in the second region 912.

The method and apparatus for providing the augmented reality-based dynamic service according to the present invention can be achieved as described above. Meanwhile, specific embodiments of the present invention have been described, but various modifications may be made thereto without departing from the scope of the present invention. Therefore, the scope of the present invention is not defined by the embodiments, but should be defined by the appended claims and equivalents thereof.

### REFERENCES

[1] S. Guven and S. Feiner, Authoring 3D Hypermedia for Wearable Augmented and Virtual Reality, Int. Symp. Wearable Comput. (2003), 118126.

[2] Google Auto Awesome. [Online]. Available: https://plus.google.com/photos/takeatour.

[3] S. Dow, J. Lee, C. Oezbek, B. Maclntyre, J. D. Bolter, and M. Gandy, Exploring spatial narratives and mixed reality experiences in Oakland Cemetery, Int. Conf. Adv. Comput. Entertain. Technol. (2005), 5160.

[4] Museum of London: Streetmuseum. [Online]. Available: http://www.museumoflondon.org.uk.

[5] LEE, Gun A., et al. AntarcticAR: An outdoor AR experience of a virtual tour to Antarctica. In: Mixed and Augmented Reality-Arts, Media, and Humanities (ISMAR-AMH), 2013 IEEE International Symposium on. IEEE, (2013). 29-38.

### DESCRIPTION OF REFERENCE NUMERALS

310: Input device

318: Output device

320: Content server

1. A method for providing an augmented reality-based dynamic service, the method comprising:
collecting data associated with a preset authoring item based on a predetermined viewing point within content to be guided, when an authoring mode for supporting a viewing point-based information provision service is executed at the time of performing a service for providing an augmented reality-based content service;
rendering authoring item-specific data collected based on a preset augmented reality content service policy, matching the rendered data to metadata corresponding to the viewing point, and storing the matched data;
checking the metadata of the viewing point of the content displayed in a preset cycle-specific viewing region based on a user's status information sensed when executing a view mode; and
as a result of the checking, when the metadata of the viewing point coincides with the viewing point-specific metadata corresponding to the content, matching the metadata to the content displayed in the viewing region and augmenting the content.

2. The method of claim 1, wherein the authoring mode is a mode which provides intonation including camera viewpoint, narration, and related multimedia content based on the viewing point of the content, and
the related multimedia content is content corresponding to highest priority based on similarity among a plurality of content searched through association analysis based on preset related data based on a scenario of the corresponding content and is provided to an author through an authoring interface in the authoring mode.

3. The method of claim 1, wherein the view mode comprises:
a process of acquiring a user's motion information in a real three-dimensional (3D) space viewed according to a user's movement or a predetermined scenario-based virtual reality space, and
a process of, when the acquired motion information coincides with viewing point-specific metadata corresponding to the content, presenting a visual cue capable of augmented reality experience to guide a user to a preferred viewing point for each object.

4. The method of claim 1, wherein the content is a real 3D space viewed according to a user's movement or a predetermined scenario-based virtual reality space.

5. The method of claim 1, wherein an augmented reality-based content service provision screen authored through the authoring mode for execution of the view mode has a plurality of divided regions including a first region and a second region, arranges and displays content display items preset for each object in the first region in a preset order, activates and displays a comment set to the corresponding object or stored by user definition according to an interrupt generated in a confirmation block marked in a portion of the first region, and displays one or all of object-related locations of the objects, which are displayed in the first region, in the second region based on a GPS coordinate-based map according to an operation of moving a user interrupt position.

6. The method of claim 5, wherein an object present on a movement path is displayed in the first region according to the movement path based on the user interrupt of the GPS coordinate-based map displayed in the second region in which the objects are displayed, so that corresponding information from a content server is provided according to the preset content display items, and at least one or more pieces of object-related information are listed and displayed.

7. An apparatus for providing an augmented reality-based dynamic service, the apparatus comprising a content server configured to:
when an authoring mode for supporting a viewing point-based information provision service is supported at the time of performing a service for providing an augmented reality-based content service and the authoring mode associated with augmented reality-based content authoring is executed from a client terminal linked via a network, collect data associated with a preset authoring item based on a predetermined viewing point within content to be guided, render authoring item-specific data collected based on a preset augmented reality content service policy, match the rendered data to metadata corresponding to the viewing point, and store the matched data; and
check the metadata of the viewing point of the content displayed in a preset cycle-specific viewing region based on a user's status information sensed at the time of executing a view mode associated with an augmented reality-based content view request from the client terminal, and as a result of the checking, when the metadata of the viewing point coincides with a viewing point-specific metadata corresponding to the content, match the metadata to the content displayed in the viewing region, and augment the content.

8. The apparatus of claim 7, wherein the authoring mode is a mode which provides intonation including camera viewpoint, narration, and related multimedia content based on the viewing point of the content, and
the related multimedia content is content corresponding to highest priority based on similarity among a plurality of content searched through association analysis based on preset related data based on a scenario of the corresponding content and is provided to an author through an authoring interface in the authoring mode.

9. The apparatus of claim 7, wherein the view mode comprises:
a process of acquiring a user's motion information in a real three-dimensional (3D) space viewed according to a user's movement or a predetermined scenario-based virtual reality space, and
a process of, when the acquired motion intonation coincides with viewing point-specific metadata corresponding to the content, presenting a visual cue capable of augmented reality experience to guide a user to a preferred viewing point for each object.
